(19) United States
(12) Patent Application Publication
(10) Pub. No.: US 2024/0317239 A1
(43) Pub. Date: Sep. 26, 2024

(54) METHOD FOR DETERMINING VEHICLE DRIVING STATUS VARIABLES WHICH ARE NOT DIRECTLY MEASURABLE

(71) Applicant: MAGNA Powertrain GmbH & Co KG, Lannach (AT)

(72) Inventors: Robert Haring, Graz (AT); Michael Kollmann, Köflach (AT); Christian Prettenthaler, Gratkorn (AT); Jan Wiechmann, Neutillmitsch (AT)

(21) Appl. No.: 18/578,835

(22) PCT Filed: Jul. 14, 2022
(86) PCT No.: PCT/EP2022/069765

§ 371 Date: Jan. 12, 2024

(30) Foreign Application Priority Data
Jul. 16, 2021 (DE) 10 2021 207 595.9

(51) Int. Cl. B60W 40/068; B60W 40/10; B60W 50/00

(52) U.S. Cl. CPC B60W 40/068; B60W 40/10; B60W 2050/0035; B60W 2520/105; B60W 2520/125; B60W 2520/14; B60W 2520/28; B60W 2720/14; B60W 2720/30

(57) ABSTRACT

A method for determining non-directly measurable driving status variables of a vehicle reads in by a sensor device and transmits to a computing device the following:
wheel speed of each vehicle wheel,
steering angle of the vehicle,
yaw angle rate,
longitudinal road inclination of the vehicle,
transverse road inclination of the vehicle.

Driving status variables are calculated by the computing device with a computational model, so that further driving variables that are difficult to measure or not directly measurable can be determined on the basis of the calculated driving status variables. The calculated and determined variables are transmitted to an actuator device to control and/or regulate the vehicle. The computational model contains a vehicle model, a tire model, and a wheel suspension model and are solved together in the computing device according to the following differential equation system:

$$( {M}_{F} + {\sum }_{i = 1}^{n \geq 3} {M}_{Ri} ) \vec{\dot{q}} + ( {\vec{k}}_{F} + {\sum }_{i = 1}^{n \geq 3} {\vec{k}}_{Ri} ) + ( {\vec{b}}_{g} {\sum }_{i = 1}^{n \geq 3} {\vec{b}}_{i} ) = \vec{0}$$

### CROSS-REFERENCE TO RELATED APPLICATIONS

This application is a National Stage of International Application No. PCT/EP2022/069765, filed Jul. 14, 2022, which claims priority to DE 10 2021 207 595.9 filed Jul. 16, 2021. The entire disclosures of each of the above applications are incorporated herein by reference.

### FIELD

The invention relates to a method for determining vehicle driving status variables which are not directly measurable of a vehicle with a control device, wherein the control device has at least one computing device, at least one sensor device and at least one actuator device, wherein in a first step the following are read in by the sensor device and transmitted to the computing device
a wheel speed of each vehicle wheel,
a steering angle of the vehicle,
a yaw angle rate,
a longitudinal road inclination of the vehicle, and
a lateral road inclination of the vehicle,
wherein, in a subsequent step driving status variables are calculated by the computing device with the help of a computational model, so that further driving variables that are difficult to measure or not directly measurable can be determined on the basis of the calculated driving status variables, and wherein, in a subsequent step the computing device transmits the calculated driving status variables and determined driving variables to the actuator device so that the vehicle can be advantageously controlled and/or regulated.

There are a number of vehicle variables, the availability of which could significantly improve the quality of the control of both vehicle dynamics and active powertrain components, such as a clutch, but measuring them is disproportionately time-consuming and therefore uneconomical in a production vehicle. These typically include vehicle variables such as a speed of the vehicle over a road, a float angle of the vehicle, the transmitted wheel torque, a yaw torque, wheel loads, a roll angle, and a pitch angle of the vehicle.

In a vehicle dynamics control system, knowledge of the float angle can be used to represent a favorable vehicle behavior for a driver, while the availability of wheel loads and a body angle can increase driving safety. In the case of all-wheel drive vehicles, knowledge of wheel loads can also be used to temporarily disable axles that are not needed (so-called “disconnect” systems), which can reduce fuel consumption. Control of active powertrain components, such as a clutch in a transfer gearbox, can be simplified by an approximate knowledge of a transmitted torque, which can reduce development costs.

### BACKGROUND

This section provides information related to the present disclosure which is not necessarily prior art.

From the document DE 10 2004 006 944 A1 a control device and a model-based control method for the real-time control of driving dynamic movements of a multi-update vehicle with at least three wheels with the following process steps are known:
Determining the horizontal dynamics of the vehicle using a single-update model;
Based on the determined horizontal dynamics of the vehicle: determining the vertical dynamics of the vehicle using a multi-update model;
Determining an individual overall dynamic for each vehicle wheel by coupling the horizontal dynamics of the vehicle with the vertical dynamics of the vehicle;
Deriving at least one control value from the determined overall dynamics, which are individual for each vehicle wheel, wherein the derived control value is fed to a control unit and/or an actuator to influence or change the driving dynamics state of the vehicle.

The disadvantage of the above control method is that it does not include and take into account the coefficient of friction that changes with the ambient conditions, wherein there is also no adaptation of the coefficient of friction as a result. In this respect, it must be assumed that the above control method does not work sufficiently well under different environmental conditions.

### SUMMARY

This section provides a general summary of the disclosure and is not a comprehensive disclosure of its full scope or all of its features.

An object to specify an improved method for determining non-directly measurable driving status variables for the control of vehicle driving dynamics and components of the motor vehicle is achieved according to the present disclosure, wherein the computational model contains a vehicle model, a tire model, and a wheel suspension model and these are solved together in the computing device according to the following differential equation system:

$$( {M}_{F} + {\sum }_{i = 1}^{n \geq 3} {M}_{Ri} ) \vec{\dot{q}} + ( {\vec{k}}_{F} + {\sum }_{i = 1}^{n \geq 3} {\vec{k}}_{Ri} ) + ( {\vec{b}}_{g} {\sum }_{i = 1}^{n \geq 3} {\vec{b}}_{i} ) = \vec{0}$$

The state vector according to the invention

$$\vec{q} = {( \dot{x} , \dot{y} , \dot{z} , \dot{ψ} , \dot{Θ} , \dot{Φ} , {ω}_{VL} , {ω}_{VR} , {ω}_{HL} , {ω}_{HL} )}^{T}$$

includes in generalized coordinates:
The speeds \dot{x}, [symbol] , [symbol] in the direction of the respective axis in an inertial vehicle coordinate system.
The rotational speeds \dot{ψ}, \dot{Θ}, \dot{Φ} around the z, y, and x axes of the vehicle in a vehicle-fixed coordinate system.
The wheel rotational speeds ω_{VL}, ω_{VR}, ω_{HL}, ω_{HR} front left, front right, rear left and rear right around the y-axis of the vehicle.

In order to determine the driving status variables that are not directly measurable, according to the present invention a ten-degree of freedom model for describing the dynamic behavior as a vehicle model of the vehicle body, a wheel suspension model and a tire model are used. The three sub-models are combined into the single computational model according to the invention, so that a possible data fusion of the results of the sub-models and resulting inconsistencies can be omitted. The index i is used to model and record the individual bodies of the vehicle, wherein
a mass matrix is denoted by M in each case,
the derivate of the state vector is denoted by \dot{\vec{q}},
gyroscopic forces are denoted by \vec{k} and
applied forces and torques are denoted by \vec{b}.

If the method according to the invention is used in a typical application of a four-wheeled motor vehicle, the computational model includes a multi-body model with five bodies, the modelling of the wheel suspensions and the use of full-fledged tire modelling.

For real-time clocked use on the control device in the vehicle, it can be advantageous to lock one degree of freedom of the vehicle model, for example the rotational speed around the z-axis of the vehicle, as well as four degrees of freedom of the wheels, such as the wheel rotation speeds, and to adopt these from a vehicle bus as input for the computational model according to the invention—the vehicle bus connects the computing device, the sensor device and the actuator device to each other for signal transmission. Accordingly, the transmitted wheel torques as well as the yaw torque of the vehicle can be generated as output variables.

The possible input signals from the vehicle bus for the computing device and the computational model according to the invention can thus be
the wheel rotation speeds ω_{VL}, ω_{VR}, ω_{HL} and ω_{HR} for each vehicle wheel of the vehicle,
a steering angle δ on the steered wheels,
the yaw rate ψ of the vehicle as the rotation speed around the z axis
a gradient θ of the road on which the vehicle is travelling, and
a transverse inclination ϕ of the road on which the vehicle is travelling.

With these input signals, the computational model according to the invention can be solved numerically with computer technology and the differential equation system thereof can be integrated. As a result, the following variables of the vehicle, which can only be measured with great effort in the real vehicle, can be determined in real time:
A vehicle reference speed over ground.
A float angle of the vehicle.
A roll rate and roll angle of the vehicle.
A pitch rate and pitch angle of the vehicle.
The wheel loads of the wheels.
The transmitted wheel forces and wheel torques.
A yaw moment of the vehicle.
A coefficient of friction of the road on which the vehicle is travelling.
A slip angle on the wheels of the vehicle, which can be evaluated as a reliable indicator of a steering tendency.

The output signals described above can be used to improve the operation of a variety of control functions for vehicle dynamics, driving safety, and vehicle components.

The wheel suspension model can preferably represent a modelling of the wheel suspensions as a vertical spring and a vertical damper for each wheel of the vehicle, wherein the wheels can be assumed to be standing horizontally on the road, the vehicle body can be assumed to carry out roll and pitch movements and a deflection in the direction of the vehicle-fixed z-axis. The following force elements can preferably be used per vehicle wheel:
a spring with constant stiffness or the spring characteristic curve thereof;
a damper with constant damping or the damping curve thereof;
a stabilizer bar with constant torsional rigidity.

The method according to the invention works in real time on the control device and provides driving status variables that are difficult to determine. Furthermore, the method according to the invention enables new approaches in vehicle control. Knowing the float angle, for example, makes it possible to depict spectacular handling, which can be kept within safe limits by the availability of the wheel loads or the body angle. Knowledge of the wheel loads also allows for more efficient metering of the axle torques and thus fuel savings. The qualitative knowledge of the transmitted wheel torque opens up new possibilities in the control of active powertrain components. For example, the development effort (test runs, manufacturing tolerances, etc.) for ensuring defined positioning accuracy can be reduced.

The method according to the invention and the computational model used accordingly differs in particular in complexity compared to known methods, wherein known methods lack accurate and high-quality determined vehicle variables.

In order to better compensate for deviations in the vehicle model or tire model and signs of wear, a method may be provided according to an advantageous embodiment of the invention wherein a coefficient of friction estimator for the tire model is used in the computing device of the computational model, with which an estimated coefficient of friction in the tire model can be updated. The parameters of the computational model which correspond to the physical values of the vehicle—for example a vehicle mass, a center of gravity, etc.—can be determined and adjusted for each target vehicle.

The coefficient of friction estimator adapts and adjusts the coefficient of friction used by the tire model according to the method according to the invention, wherein the coefficient of friction estimator compares the lateral and longitudinal accelerations of the vehicle measured and possibly transmitted via the vehicle bus with the respective accelerations calculated by the computational model and returns them to the tire model, so that the coefficient of friction of the tire model can be updated. As a result, even small deviations in the parameters of the computational model can be compensated, for example in a comparison with the original equipment of the vehicle, on which the parameterization of the vehicle model is based, or worn tires or fitted tires that are different from the original equipment. This ensures very robust operation of the method and high accuracy of the determined vehicle variables in various environmental conditions.

The invention also includes a device for determining non-directly measurable driving status variables of a vehicle with a control device, wherein the control device has at least one computing device, at least one sensor device and at least one actuator device, which is characterized in that the computing device is suitable for carrying out a method as described herein.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

In the following, schematic diagrams show exemplary embodiments of the invention. In the figures:

FIG. 1 shows a method and a computational model in the form of a block diagram,

FIG. 2 shows a possible assignment of the parameters of the computational model and

FIG. 3 shows a possible definition of the axes used by the method and in the computational model according to Schramm, Hiller and Bardini (D. Schramm, M. Hiller and R. Bardini, Modellbildung und Simulation der dynamik von Kraftfahrzeugen. Berlin, Heidelberg: Springer Berlin Heidelberg, 2018).

### DETAILED DESCRIPTION

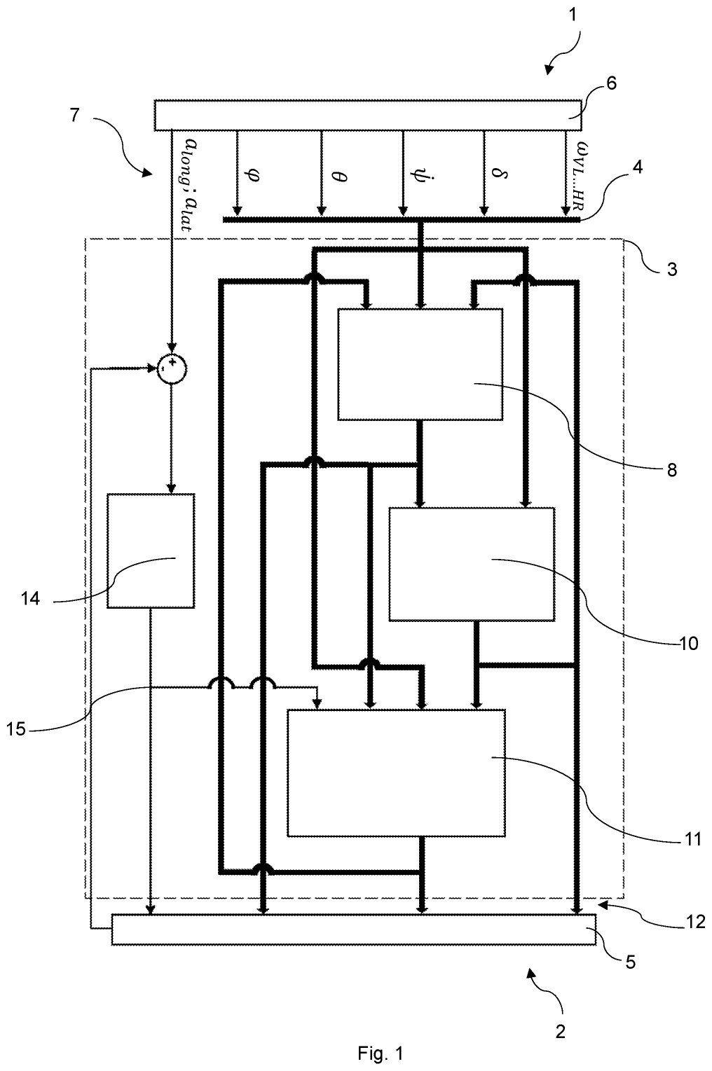

FIGS. 1 to 3 show a method 1 according to the invention for the determination of non-directly measurable driving status variables 2 with a computing device 3, wherein the driving status variables 2 are transferred from the computing device 3 to an actuator device 5 via a vehicle bus 4. At the inputs, a sensor device 6 detects the following as input variables 7
the wheel rotation speeds ω_{VL}, ω_{VR}, ω_{HL} and ω_{HR} for each vehicle wheel 13 of the vehicle 9,
a steering angle δ on the steered wheels 13,
a yaw rate ψ; of the vehicle 9 as a rotational speed about the z-axis
a gradient θ of the road on which the vehicle 9 is travelling,
a transverse inclination ϕ of the road on which the vehicle 9 is travelling, and
a measured lateral aₗₐₜ and longitudinal a_{long} acceleration of the vehicle 9.

These input variables are transmitted via the vehicle bus 4 to a ten degree of freedom vehicle model 8 for describing the dynamic behavior of the vehicle body of the vehicle 9, wherein five input variables 7 superimpose a total of five entries of a state vector \dot{\vec{q}} of the vehicle model 8 and thus block them. Downstream of the vehicle model 8 are a suspension model 10 and a tire model 11, but these models react on the vehicle model 8 with their output variables 12 and thus influence it in a feedback manner.

The suspension model 10 is a modelling of the wheel suspensions as a vertical spring and vertical damper for each vehicle wheel 13 of the vehicle 9, wherein the wheels 13 are assumed to be standing horizontally on the road, the vehicle body is assumed to carry out roll and pitch movements, and a deflection in the direction of a z-axis is assumed. The following force elements are used for each vehicle wheel x:
a spring with a constant stiffness or the spring characteristic curve thereof,
a damper with a constant damping or the damping characteristic curve thereof, and
a stabilizer bar with a constant torsional rigidity.

The tire model 11 is an approximation of the tire behavior including a coefficient of friction dependence, a longitudinal and lateral force characteristic, a degressive influence of the wheel load and a combined tire behavior. The coefficient of friction estimator 14 compares the measured accelerations with the acceleration calculated by the method 1 and feeds a weighted difference back to the tire model 11, which can adjust and update its coefficient of friction 15 within the model.

Below, the notation is as follows:

$${\vec{\dot{r}}}_{i}^{n , T , k}$$

r stands for a vector or a bold matrix or tensor.
the dot above the r stands for the first derivative against time.
the arrow above the dot above r stands for a vector.
n stands for potency.
T stands for a transposed representation of r.
k stands for the respective coordinate system.
i stands for the respective selection of the component of the vehicle.

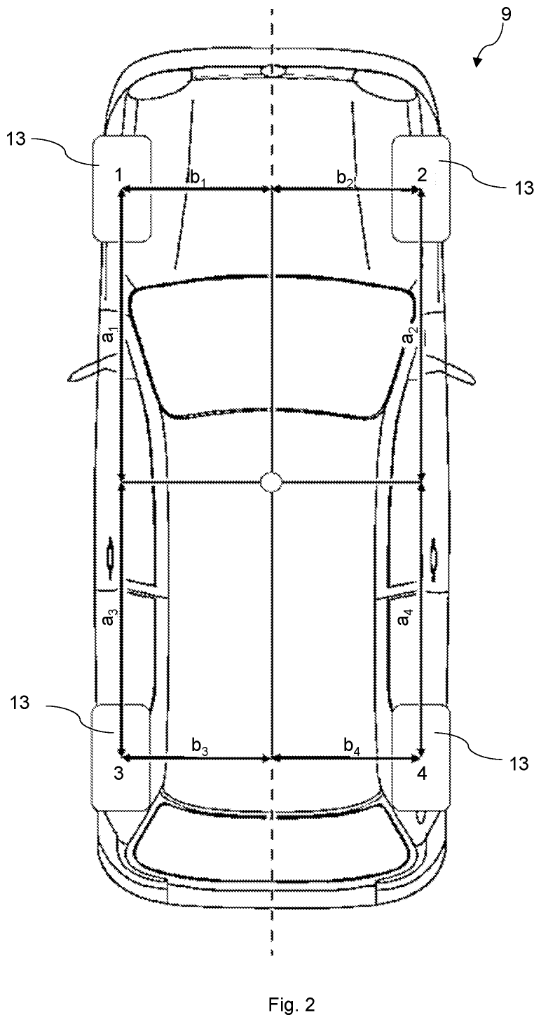

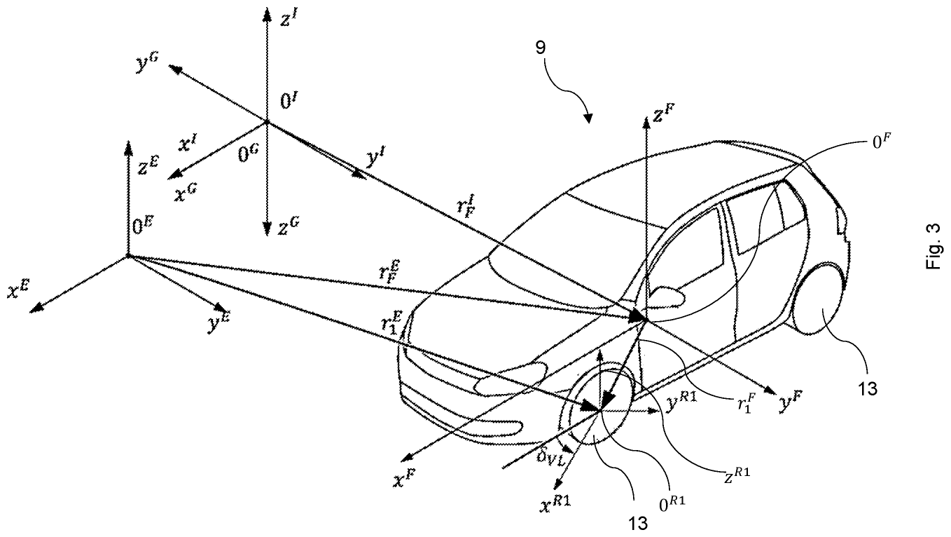

In the following, the computational model according to the invention is shown parametrized using FIGS. 2 and 3. The 10×10 mass matrix M_{F}=(M_{zs}) with z=s∈{1, . . . , 10} includes the following non-zero entries:

$$\begin{matrix}{m}_{11} = {m}_{F} {cos}^{- 2} ( θ ) \\ {m}_{12} = - {m}_{F} tan ( θ ) tan ( ϕ ) {cos}^{- 1} ( θ ) \\ {m}_{13} = - {m}_{F} tan ( θ ) \\ {m}_{15} = {m}_{F} {z}_{dyn} cos ( ψ ) {cos}^{- 1} ( θ ) \\ {m}_{16} = {m}_{F} {z}_{dyn} cos ( Θ ) sin ( ψ ) {cos}^{- 1} ( θ ) \\ {m}_{21} = - {m}_{F} tan ( θ ) tan ( ϕ ) {cos}^{- 1} ( θ ) \\ {m}_{22} = {m}_{F} + {m}_{F} {tan}^{2} ( ϕ ) {cos}^{- 2} ( θ ) \\ {m}_{23} = {m}_{F} tan ( ϕ ) {cos}^{- 1} ( θ ) \\ {m}_{25} = {m}_{F} {z}_{dyn} ( sin ( ψ ) {cos}^{- 1} ( ϕ ) - cos ( ψ ) tan ( θ ) tan ( ϕ ) ) \\ {m}_{26} = {m}_{F} {z}_{dyn} cos ( Θ ) ( cos ( ψ ) {cos}^{- 1} ( ϕ ) + sin ( ψ ) tan ( θ ) tan ( ϕ ) ) \\ {m}_{31} = - {m}_{F} tan ( θ ) \\ {m}_{32} = {m}_{F} tan ( ϕ ) {cos}^{- 1} ( θ ) \\ {m}_{33} = {m}_{F} \\ {m}_{35} = {m}_{F} {z}_{dyn} ( - cos ( ψ ) sin ( θ ) + sin ( ψ ) cos ( θ ) sin ( ϕ ) ) \\ {m}_{36} = - {m}_{F} {z}_{dyn} cos ( Θ ) ( sin ( ψ ) sin ( θ ) + cos ( ψ ) cos ( θ ) sin ( ϕ ) ) \\ {m}_{44} = 0.25 ( 2 {Θ}_{{SF}_{xx}}^{F} + {Θ}_{{SF}_{yy}}^{F} + {Θ}_{{SF}_{zz}}^{F} + 2 cos ( θ ) ( - 2 {Θ}_{{SF}_{xx}}^{F} + {Θ}_{{SF}_{yy}}^{F} + {Θ}_{{SF}_{zz}}^{F} ) + 2 {cos}^{2} ( θ ) cos ( 2 ϕ ) ( - 2 {Θ}_{{SF}_{yy}}^{F} + {Θ}_{{SF}_{zz}}^{F} ) ) \\ {m}_{45} = {m}_{54} = ( {Θ}_{{SF}_{yy}}^{F} - {Θ}_{{SF}_{zz}}^{F} ) cos ( Θ ) sin ( Φ ) cos ( Φ ) \\ {m}_{46} = - {θ}_{{SF}_{xx}}^{F} sin ( Θ ) \\ {m}_{55} = 0.5 ( {Θ}_{{SF}_{yy}}^{F} + {Θ}_{{SF}_{zz}}^{F} + cos ( 2 Φ ) ( {Θ}_{{SF}_{yy}}^{F} - {Θ}_{{SF}_{zz}}^{F} ) ) \\ {m}_{64} = - {Θ}_{{SF}_{xx}}^{F} sin ( Θ ) \\ {m}_{66} = {Θ}_{{SF}_{xx}}^{F}\end{matrix}$$

The 10×10 mass matrices M_{Ri}=(m_{zs}) with z=s∈{1, . . . , 10} of the multibody vehicle model include the following non-zero entries:

$$\begin{matrix}{m}_{24} = {m}_{42} = {m}_{{R}_{i}} {cos}^{- 1} ( ϕ ) ( {a}_{i} cos ( ψ ) - {b}_{i} sin ( ψ ) + tan ( θ ) sin ( ϕ ) ( {b}_{i} cos ( ψ ) + {a}_{i} sin ( ψ ) ) ) \\ {m}_{44} = {m}_{{R}_{i}} ( {a}_{i}^{2} + {b}_{i}^{2} ) + {Θ}_{{Si}_{zz}}^{Ri} ( θ ) \\ {m}_{21} = - {m}_{{R}_{i}} tan ( θ ) tan ( ϕ ) {cos}^{- 1} ( θ ) \\ {m}_{22} = {m}_{{R}_{i}} ( {sec}^{2} ( θ ) {cos}^{- 2} ( ϕ ) - {tan}^{2} ( θ ) ) \\ {m}_{75} = {Θ}_{{Si}_{zz}}^{Ri}\end{matrix}$$

The 10×1 gyroscopic force vector \vec{k}_{F}=(k_{z}) with z∈{1, . . . , 10} of the vehicle includes the following non-zero entries:

$$\begin{matrix}{k}_{1} = - {m}_{F} {z}_{dyn} {cos}^{- 1} ( θ ) ( sin ( ψ ) \dot{Θ} ( sin ( Θ ) \dot{Φ} + \dot{ψ} ) - cos ( Θ ) cos ( ψ ) \dot{Θ} \dot{ψ} ) \\ {k}_{2} = {m}_{F} {z}_{dyn} ( cos ( Θ ) ( sin ( ψ ) {cos}^{- 1} ( ϕ ) - cos ( ψ ) tan ( θ ) tan ( ϕ ) ) \dot{Φ} \dot{ψ} + ( cos ( ψ ) {cos}^{- 1} ( ϕ ) + sin ( ψ ) tan ( θ ) tan ( ϕ ) ) \dot{Θ} ( sin ( Θ ) \dot{Φ} + \dot{ψ} ) ) \\ {k}_{3} = {m}_{F} {z}_{dyn} ( - cos ( Θ ) ( sin ( θ ) cos ( ψ ) + sin ( ψ ) cos ( θ ) sin ( ϕ ) ) \dot{Φ} \dot{ψ} + ( sin ( ψ ) sin ( θ ) + cos ( ψ ) cos ( θ ) sin ( ϕ ) ) \dot{Θ} ( sin ( Θ ) \dot{Φ} + \dot{ψ} ) ) \\ {k}_{4} = 0.5 cos ( Θ ) ( ( {Θ}_{{SF}_{yy}}^{F} - {Θ}_{{SF}_{zz}}^{F} ) cos ( Θ ) sin ( 2 ϕ ) \dot{Φ} \dot{ψ} + \dot{Θ} ( \text{} 2 {Θ}_{{SF}_{xx}}^{F} sin ( Θ ) \dot{ψ} + ( - {Θ}_{{SF}_{yy}}^{F} - {Θ}_{{SF}_{zz}}^{F} + ( {Θ}_{{SF}_{yy}}^{F} - {Θ}_{{SF}_{zz}}^{F} ) cos ( 2 Φ ) ) ( \dot{Φ} + sin ( Θ ) \dot{ψ} ) ) ) \\ {k}_{5} = 0.5 cos ( Θ ) ( {Θ}_{{SF}_{yy}}^{F} + {Θ}_{{SF}_{zz}}^{F} + ( {Θ}_{{SF}_{yy}}^{F} - {Θ}_{{SF}_{zz}}^{F} ) cos ( 2 Φ ) ) \dot{Φ} \dot{ψ} - ( {Θ}_{{SF}_{yy}}^{F} - {Θ}_{{SF}_{zz}}^{F} ) sin ( 2 Φ ) \dot{Θ} ( \dot{Φ} + sin ( Θ ) \dot{ψ} ) ) \\ {k}_{6} = - {Θ}_{{SF}_{xx}}^{F} cos ( Θ ) \dot{Θ} \dot{ψ}\end{matrix}$$

The 10×1 gyroscopic force vectors \vec{k}_{Ri}=(k_{z}) with z∈{1, . . . , 10} of the multibody include the following non-zero entries:

$${k}_{1} = {m}_{{R}_{i}} {cos}^{- 1} ( θ ) ( {b}_{i} sin ( ψ ) - {a}_{i} cos ( ψ ) {\dot{ψ}}^{2} {k}_{2} = {m}_{{R}_{i}} ( {cos}^{- 1} ( ϕ ) ( {b}_{i} cos ( ψ ) + {a}_{i} sin ( ψ ) ) + {b}_{i} sin ( ψ ) - {a}_{i} cos ( ψ ) ) tan ( θ ) tan ( ϕ ) {\dot{ψ}}^{2} )$$

The applied 10×1 forces and torques vector \vec{b}_{g}=(b_{z}) with z∈{1, . . . , 10} of the vehicle includes the following non-zero entries:

$$\begin{matrix}{b}_{1} = - {cos}^{- 1} ( θ ) {F}_{W} cos ( Θ ) cos ( ψ ) - g tan ( θ ) {m}_{F} \\ {b}_{2} = g {cos}^{- 1} ( θ ) {m}_{F} tan ( ϕ ) + {F}_{W} cos ( Θ ) ( {cos}^{- 1} ( ϕ ) sin ( ψ ) + cos ( ψ ) tan ( ϕ ) tan ( θ ) ) \\ {b}_{3} = {m}_{F} \cdot g + {F}_{W} cos ( Θ ) cos ( ψ ) ) sin ( θ ) + {F}_{W} cos ( Θ ) cos ( ψ ) ) sin ( θ ) - cos ( θ ) sin ( ϕ ) sin ( ψ ) ) \\ {b}_{7} = - {M}_{{AB}_{VL}} - {M}_{{R}_{VL}} + {F}_{{G}_{VL}}^{R 1} \cdot {r}_{{dyn}_{VL}} \\ {b}_{8} = - {M}_{{AB}_{VR}} - {M}_{{R}_{VR}} + {F}_{{G}_{VR}}^{R 2} \cdot {r}_{{dyn}_{VR}} \\ {b}_{9} = - {M}_{{AB}_{HL}} - {M}_{{R}_{HL}} + {F}_{{G}_{HL}}^{R 3} \cdot {r}_{{dyn}_{HL}} \\ {b}_{10} = - {M}_{{AB}_{HR}} - {M}_{{R}_{HR}} + {F}_{{G}_{HR}}^{R 4} \cdot {r}_{{dyn}_{HR}}\end{matrix}$$

The applied 10×1 forces and torques vectors \vec{b}ᵢ=(b_{z}) with z∈{1, . . . , 10} of the multiple components include the following non-zero entries:

$$\begin{matrix}{b}_{1} = {cos}^{- 1} ( θ ) ( - {F}_{{G}_{ix}}^{R i} cos ( {δ}_{i} + ψ ) + g sin ( θ ) {m}_{{R}_{i}} + {F}_{{G}_{iy}}^{R i} sin ( {δ}_{i} + ψ ) ) \\ {b}_{2} = {cos}^{- 1} ( θ ) g tan ( ϕ ) {m}_{{R}_{VL}} + cos ( {δ}_{VL} + ψ ) ( - {cos}^{- 1} ( ϕ ) {F}_{{G}_{iy}}^{R i} + {F}_{{Ri}_{ix}} tan ( ϕ ) tan ( θ ) ) - sin ( {δ}_{i} + ψ ) ( {cos}^{- 1} ( ϕ ) {F}_{{G}_{iy}}^{R i} + {F}_{{G}_{iy}}^{R i} tan ( θ ) tan ( ϕ ) ) \\ {b}_{3} = - {F}_{{FD}_{i}}^{F} cos ( θ ) cos ( ϕ ) \\ {b}_{4} = ( {b}_{i} {F}_{{G}_{ix}}^{R i} - {a}_{i} {F}_{{G}_{iy}}^{R i} ) cos ( {δ}_{VL} ) - ( {a}_{i} {F}_{R {i}_{ix}} + {b}_{i} {F}_{{G}_{iy}}^{R i} ) sin ( {δ}_{i} ) + g \cdot {m}_{{R}_{i}} sin ( θ ) ( {b}_{i} cos ( ψ ) + {a}_{i} sin ( ψ ) + cos ( θ ) sin ( ϕ ) ( {b}_{i} sin ( ψ ) - {a}_{i} cos ( ψ ) ) ) ) \\ {b}_{5} = {F}_{{FD}_{i}}^{F} ( {a}_{i} cos ( Θ ) + {b}_{i} sin ( Θ ) sin ( Φ ) ) \\ {b}_{6} = - {b}_{i} {F}_{{FD}_{i}}^{F} cos ( Θ ) cos ( Φ )\end{matrix}$$

### REFERENCE SIGN LIST

1. method/block diagram
2. driving status variables
3. computing device
4. vehicle bus
5. actuator device
6. sensor device
7. input variables
8. vehicle model
9. vehicle
10. wheel suspension model
11. tire model
12. output variables
13. vehicle wheel
14. coefficient of friction estimator
15. coefficient of friction
16. vehicle distance in longitudinal vehicle direction a
17. vehicle distance in lateral vehicle direction b
18. applied forces \vec{b}
19. steering angle δ
20. spring and damper force F_{FD}
21. sliding forces at the wheel contact points F_{G}
22. aerodynamic drag force in the vehicle coordinate system F_{W}
23. gravitational acceleration g
24. selection of the component i with wheels 1 to 4 or VL, VR, HL, HR; with the vehicle F or the wheel R
25. extension of the component iⱼ by a rotational or translational direction of motion (θFₓₓ as a rotation about the x-axis or F_{VL}_{ₓ}^{RI} as a movement in the x-axis)
26. gyroscopic forces \vec{k}
27. mass of vehicle body m_{F}
28. mass of the wheel m_{R}
29. mass matrix M
30. drive and braking torque M_{AB}
31. rolling resistance torque M_{R}
32. Generalized coordinates \vec{q}
33. location vector \vec{r}
34. dynamic tire radius r_{dyn}
35. static tire radius rₛₜₐₜ
36. moment of inertia at center of gravity Θₛ
37. vertical movement of the vehicle body (simplified representation) z_{dyn}
38. pitch angle, angle around the vehicle's transverse axis Θ
39. yaw angle, angle around the vehicle's vertical axis ψ
40. roll angle, angle around the vehicle's longitudinal axis ϕ
41. wheel rotation speed ω
42. gradient of the road θ
43. inclination of the road ϕ

What is claimed is:

1. A method (1) for determining driving status variables that are not directly measurable of a vehicle using a control device, wherein the control device has at least one computing device, at least one sensor device, and at least one actuator device, the method comprising:
in a first step, reading in, by the sensor device, and transmitting to the computing device the following information:
a wheel speed of each vehicle wheel,
a steering angle of the vehicle,
a yaw angle rate,
a longitudinal road inclination of the vehicle and
a transverse road inclination of the vehicle;
in a subsequent step, calculating driving status variables by the computing device using a computational model, such that further driving variables that are difficult to measure or not directly measurable are determined on the basis of the calculated driving status variables, and
in a subsequent step transmitting, by the computing device, the calculated driving status variables and determined driving variables to the actuator device, such that the vehicle is advantageously controlled and/or regulated using the calculated driving variables and determined driving variables
wherein the computational model contains a vehicle model (8), a tire model, and a wheel suspension model, which are solved together in the computing device according to the following differential equation system:
$$( {M}_{F} + {\sum }_{i = 1}^{n \geq 3} {M}_{R i} ) \vec{\dot{q}} + ( {\vec{k}}_{F} + {\sum }_{i = 1}^{n \geq 3} {\vec{k}}_{R i} ) + ( {\vec{b}}_{g} + {\sum }_{i = 1}^{n \geq 3} {\vec{b}}_{i} ) = \vec{0}$$

2. The method as claimed in claim 1, wherein a coefficient of friction estimator for the tire model is used in the computing device of the computational model, with which an estimated coefficient of friction in the tire model is updated.

3. A device for determining non-directly measurable driving status variables of a vehicle with a control device, wherein the control device has at least one computing device, at least one sensor device, and at least one actuator device, wherein the computing device carries out the method according to claim 1.

4. The method as claimed in claim 1, wherein a state vector
$$\vec{q} = {( \dot{x} , \dot{y} , \dot{z} , \dot{ψ} , \dot{Θ} , \dot{Φ} , {ω}_{V L} , {ω}_{V R} , {ω}_{H L} , {ω}_{H L} )}^{T}$$
includes in generalized coordinates:
speeds \dot{x}, [symbol] , [symbol] in the direction of the respective axis in an inertial vehicle coordinate system;
rotational speeds \dot{ψ}, \dot{Θ}, \dot{Φ} around the z, y, and x axes of the vehicle in a vehicle-fixed coordinate system; and
wheel rotational speeds ω_{VL}, ω_{VR}, ω_{HL}, ω_{HR} front left, front right, rear left and rear right around the y-axis of the vehicle.

5. The method according to claim 1, wherein the computational model includes a multi-body model with five bodies, modeling of wheel suspensions, and full-fledged tire modeling.

6. The method according to claim 1, wherein the vehicle model is a ten-degree of freedom vehicle model.

7. The method according to claim 1, wherein the method locks one degree of freedom of the vehicle model and four degrees of freedom of the wheels, and adopts these as an input for the computational model.

8. The method according to claim 7, wherein a vehicle bus receives the input and connects the computing device, the sensor device, and the actuator device to each other for signal transmission, wherein the method includes generating wheel torques and yaw torque as output variables.

9. The method according to claim 1, wherein the further driving variables that are difficult to measure or not directly measurable comprise at least one of:
a vehicle reference speed over ground;
a float angle of the vehicle;
a roll rate and roll angle of the vehicle;
a pitch rate and pitch angle of the vehicle;
wheel loads of the wheels;
transmitted wheel forces and wheel torques;
a yaw moment of the vehicle;
a coefficient of friction of the road on which the vehicle is travelling; or
a slip angle on the wheels of the vehicle.

10. The method according to claim 1, wherein the wheel suspension model models the wheel suspensions as a vertical spring and a vertical damper for each wheel of the vehicle.

11. The method according to claim 10, wherein in the wheel suspension model, the following force elements are used per vehicle wheel:
a spring with constant stiffness or the spring characteristic curve thereof;
a damper with constant damping or the damping curve thereof; and
a stabilizer bar with constant torsional rigidity.

12. The method as claimed in claim 2, wherein the coefficient of friction estimator compares the lateral and longitudinal accelerations of the vehicle measured and possibly transmitted via the vehicle bus with the respective accelerations calculated by the computational model and returns them as a weighted difference back to the tire model to update the coefficient of friction within the tire model.

13. The method as claimed in claim 1, wherein the suspension model and the tire model are downstream of the vehicle model, and the outputs of the suspension model and the tire model influence the vehicle model in a feedback manner.
